(19) United States
(12) Patent Application Publication
(10) Pub. No.: US 2014/0099832 A1
(43) Pub. Date: Apr. 10, 2014

(54) CONNECTOR SOCKET

(71) Applicant: ADVANCED-CONNECTEK INC., New Taipei City (TW)

(72) Inventor: Ming-Young CHANG, New Taipei City (TW)

(73) Assignee: ADVANCED-CONNECTEK INC., New Taipei City (TW)

(21) Appl. No.: 13/770,248

(22) Filed: Feb. 19, 2013

(30) Foreign Application Priority Data
Oct. 4, 2012 (TW) 101219237

(51) Int. Cl. H01R 13/516

(52) U.S. Cl. CPC H01R 13/516
USPC 439/660

(57) ABSTRACT

A connector socket includes an insulation body with a terminal receptacle formed therein, multiple terminals securely received in the terminal receptacle of the insulation body and a metal casing covering the insulation body and composed of an upper casing and a lower casing connected to the upper casing via a connecting part which is formed on corresponding sides of the upper casing and of the lower casing.

A method for manufacturing an oxide thin film comprises: providing a coating material comprising first precursor material, fuel material and solvent; coating the coating material on a substrate; and performing annealing treatment to the coating material on the substrate, thereby converting the coating material to an oxide thin film.

### CROSS-REFERENCE TO RELATED APPLICATION

This application claims priority from application No. 101219237, filed on Oct. 4, 2012 in the Taiwan Intellectual Property Office.

### FIELD OF THE INVENTION

The invention relates to a connector socket, more particularly, to a two-pieced connector socket made from a single mold.

### BACKGROUND OF THE INVENTION

As USB (Universal Series Bus) connector has plug-in feature and fast transmission speed, it has been widely used in all kinds of information transmission media. Also, following the advances of modern technology, requirements in information transmission speed and stability are drastically increased.

Currently, USB2.0 is the mainstream for data transmission. However, due to the large data volume and fast transmission speed requirements, performance and characteristics of USB2.0 no longer satisfy the general needs. Changes and upgrades to the currently available USB 2.0 has become an issue to be solved by the industry. As a solution to the problem the USB 2.0 has, a new product called USB 3.0 is produced to the market, which transcends all the characteristics the old USB 2.0 has and has features such as low power consumption, high coordination efficiency and large transmission speed, up to 5 Gbps compared to 480 Mbps of the conventional transmission speed.

All the USBs require some kind of protection for the fragile terminals. For that, a metallic casing is developed to protect the terminals and block noises affecting the terminals. Conventional method includes production of an integral metallic body and production of a two-part metallic body.

With reference to FIG. 1, a conventional connector socket 1 is shown and composed of an insulation body 11 having a terminal receptacle 12 formed therein, a plurality of terminals 13 to be received in the terminal receptacle 12 of the insulation body 11 and a casing 14 covering the insulation body 11 to block interferences from the environment and having through holes 15 defined in a side face thereof to form welding segments 16 on a side face of the casing 14. The welding segments 16 are formed for combination with a printed circuit board in future process. Therefore, it is necessary to have the welding segments 16. However, due to the process requirement for the welding segments 16, the integrity of the overall casing 14 is damaged and thus the durability of the casing 14 is also decreased.

In order to overcome the aforementioned durability and integrity problems, a different casing is introduced to the market. The casing is composed of two halves each having multiple welding segments formed on an edge thereof Each half of the casing is uniquely formed in a different mold so that after the two halves are formed, a combination process is necessary to combine the two halves to form the casing. Even though, the durability and integrity of the casing are maintained, an additional combination process for the two halves is added. Furthermore, due to the two molds for each of the unique halves of the casing, the manufacture cost is increased.

### SUMMARY OF THE INVENTION

The primary objective of the present invention is to provide a connector socket composed of two pieces that are made from the identical mold so that not only the integrity of the casing is maintained, the manufacture cost is also low.

In order to accomplish the aforementioned objective, the connector socket constructed in accordance with the present invention includes an insulation body having therein a terminal receptacle, multiple terminals securely received in the terminal receptacle of the insulation body and a metal casing covering the insulation body and composed of an upper casing and a lower casing connected to the upper casing via a connecting means.

In a preferred embodiment, the connecting means is formed on two corresponding sides of the upper casing and of the lower casing.

In a preferred embodiment, the connecting means is formed on a selected left side and a right side of the upper casing and of the lower casing.

In still another embodiment of the present invention, the connecting means is deformable so as to combine the upper casing and the lower casing.

In another embodiment of the present invention, the connecting means is composed of a pressing part and a receiving part receiving the deformed pressing part to complete the combination of the upper casing and the lower casing.

Still, in another embodiment of the present invention, multiple welding segments are formed on an edge of the metal casing.

The connector socket is a Micro USB connector socket.

### BRIEF DESCRIPTION OF THE DRAWINGS

FIG. 1 is an exploded perspective view showing a conventional connector;

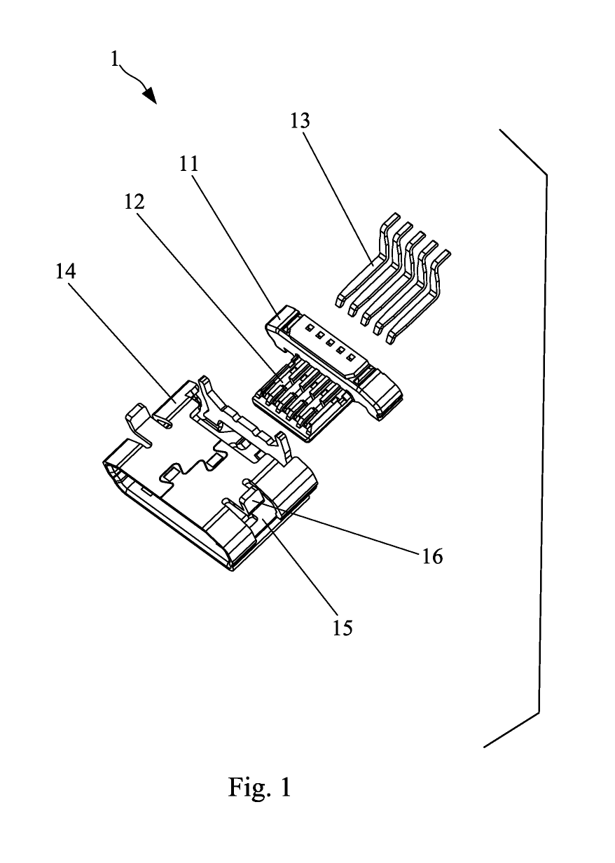

FIG. 2 is perspective view showing a preferred embodiment of the connector socket of the present invention;

FIG. 3 is a perspective view showing the connector socket of the present invention is displayed for receiving therein the insulation body and terminals;

FIG. 4 is a schematic view showing the application of the connector socket of the present invention;

FIG. 5 is still another schematic view showing the application of the pressing part of the connector socket of the present invention;

FIG. 6 is a perspective view showing that the pressing part is depressed; and

FIG. 7 is a perspective view showing another preferred embodiment of the connector socket of the present invention.

### DETAILED DESCRIPTION OF THE INVENTION

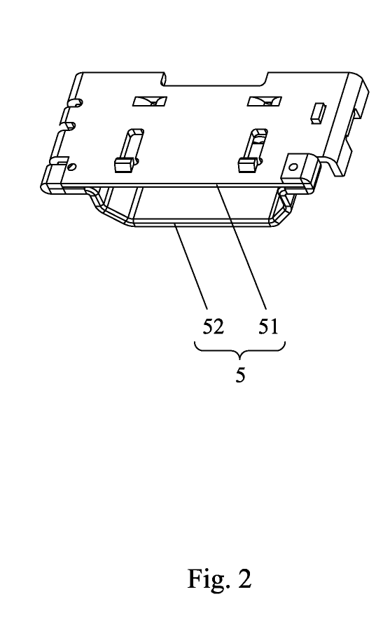

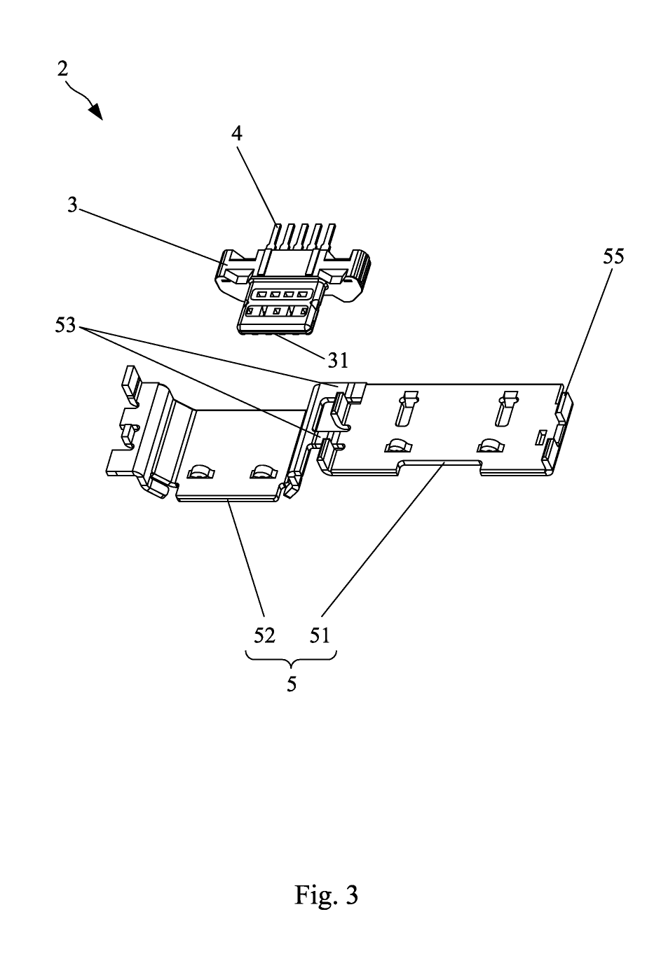

With reference to FIGS. 2 and 3, a Micro USB connector 2 constructed in accordance with the present invention includes an insulation body 3 having a terminal receptacle 31 defined therein, multiple terminals 4 securely received in the terminal receptacle 31 and a metal casing 5.

The metal casing 5 covering the insulation body 3 is composed of an upper casing 51 and a lower casing 52 connected to the upper casing 51 via a deformable connecting part 53. The connecting part 53 is formed on a side face of each of the upper casing 51 and the lower casing 52. Preferably, the connecting part 53 is formed on a left side of the upper casing 51 and a corresponding right side of the lower casing 52, which corresponds to the left side of the upper casing 51. That is, the connecting part 53 is formed on a selected one of the left side and the right side of the upper casing 51 and the lower casing 52. Still preferably, the connecting part 53 is formed on a selected one of an upper side and a lower side of the upper casing 51 and the lower casing 52. From the depiction of the accompanying drawings, it is noted that there are two connecting parts 53 formed between the upper casing 51 and the lower casing 52.

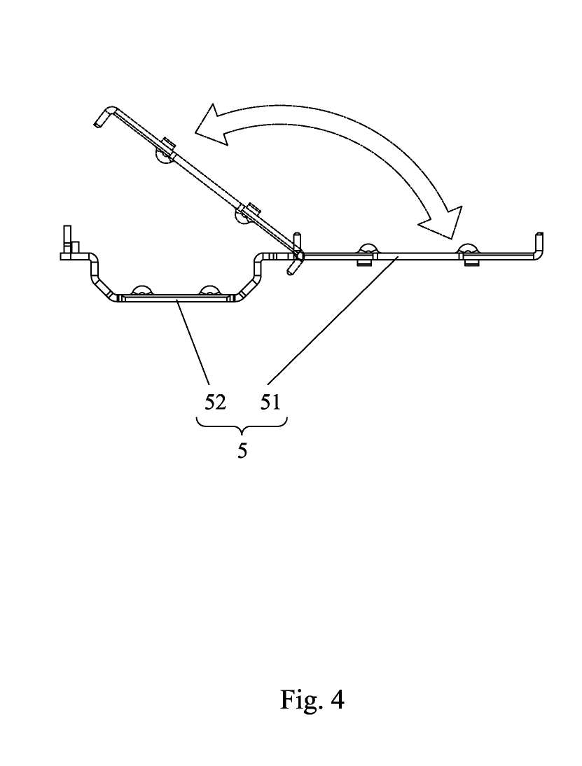

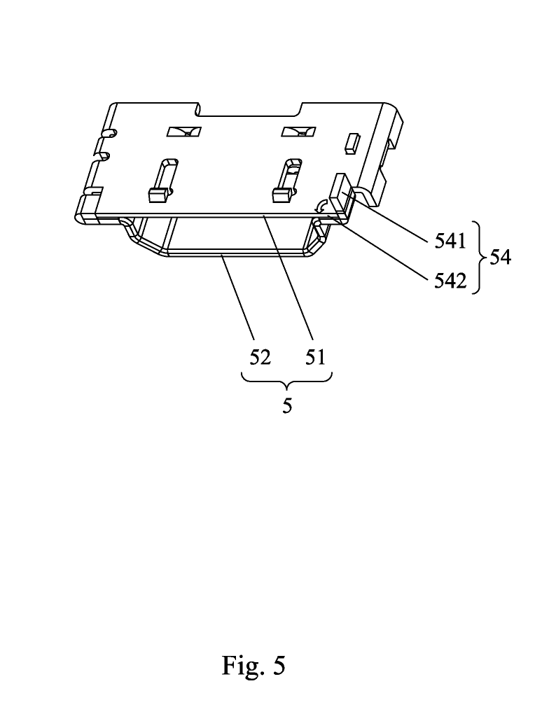

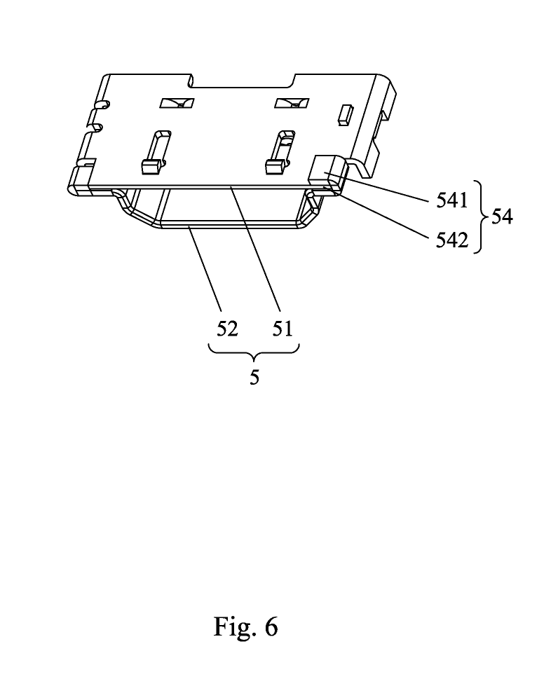

Preferably, there are multiple welding segments 55 formed on a side face of the metal casing 5 for engagement with a printed circuit board (not shown). With reference to FIGS. 3, 4, 5 and 6, it is noted that the connecting part 53 connects the lower casing 52 to the upper casing 51. When combination of the upper casing 51 and the lower casing 52 is necessary, the connecting part 53 is bent to allow the upper casing 51 to be on top of the lower casing 52. The connector socket of the preferred embodiment of the present invention further has a combination measure 54 formed between the upper casing 51 and the lower casing 52. The combination measure 54 is composed of a pressing element 541 and a receiving element 542. The receiving element 542 is formed on the upper casing 51 and the pressing element 541 is formed on the lower casing 52 such that when the combination of the upper casing 51 and the lower casing 52 is necessary, the pressing element 541 is deformed (bent) toward the receiving element 542 to complete the combination. Even though, the combination measure 54 is described, there are modifications, alternations and other changes originally motivated by the concept of the embodiments of the present invention should also be included in the scope of protection.

It is also noted that the bent of the pressing element 541 is able to be completed while the lower casing 52 is still in the manufacture mold. As a result of this feature, the manufacture cost for extra manpower to complete the assembly of the upper casing 51 and the lower casing 52 is low.

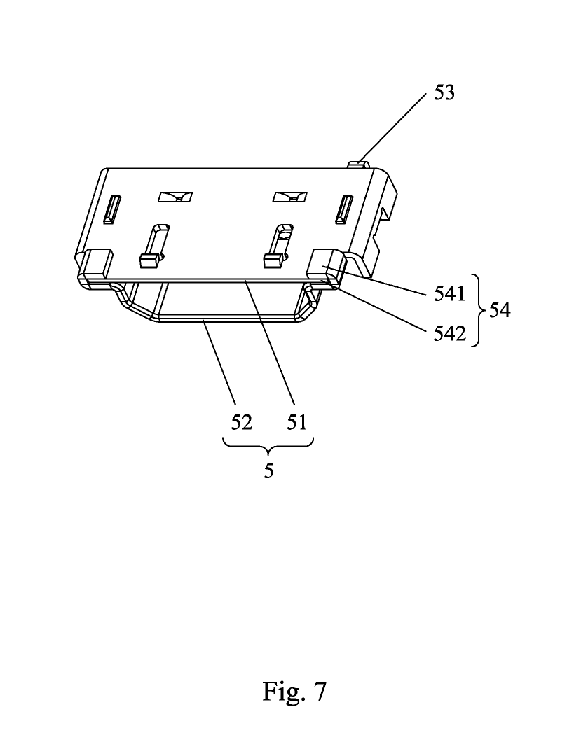

With reference to FIG. 7, another embodiment of the present invention is shown, wherein this embodiment is substantially the same as the embodiment shown previously. The difference therebetween is that there is only one connecting part 53. Also, there are two connecting measures 54 on the corresponding sides of the upper casing 51 and the lower casing 52. Each connecting measure 54 is composed of a pressing element 541 and a receiving element 542. After the pressing element 541 is pressed forward the receiving element 542, the combination of the upper casing 51 and the lower casing 542 is completed.

From the above description, it is noted that the present invention has the following advantages:

Only one mode is required.

Combination between the upper casing and the lower casing can be completed while the casings are still in the mold. Manufacture cost is greatly reduced.

Multiple welding segments increase the overall durability.

What is claimed is:

1. A connector socket comprising:
an insulation body with a terminal receptacle formed therein;
multiple terminals securely received in the terminal receptacle of the insulation body; and
a metal casing covering the insulation body and composed of an upper casing and a lower casing connected to the upper casing via a connecting part which is formed on corresponding sides of the upper casing and of the lower casing.

2. The connector socket as claimed in claim 1, wherein the connecting part is formed on a selected one of a left side and a right side of the upper casing and of the lower casing.

3. The connector socket as claimed in claim 1, wherein the connecting part is formed on a selected one of a front side and a rear side of the upper casing and of the lower casing.

4. The connector socket as claimed in claim 1 further comprising a connecting measure formed on the corresponding sides of the upper casing and of the lower casing such that the upper casing is combined with the lower casing.

5. The connector socket as claimed in claim 4, wherein the connecting measure is composed of a receiving element and a pressing element deformable toward the receiving element to complete the combination of the upper casing and the lower casing.

6. The connector socket as claimed in claim 1 further comprising multiple welding segments formed on a side face of the metal casing.

7. The connector socket as claimed in claim 1 being a Micro USB connector socket.
